(19) United States
(12) Patent Application Publication
(10) Pub. No.: US 2013/0176451 A1
(43) Pub. Date: Jul. 11, 2013

(54) SYSTEM FOR ACQUIRING VIEWS FOR PRODUCING HIGH DEFINITION VIRTUAL STROLLS

(71) Applicant: Matteo Minetto, Paris (FR)

(72) Inventor: Matteo Minetto, Paris (FR)

(21) Appl. No.: 13/348,436

(22) Filed: Jan. 11, 2012

(51) Int. Cl. H04N 5/232

(52) U.S. Cl. 348/211.99; 348/E05.042

(57) ABSTRACT

The invention relates to a system for acquiring a plurality of views of a path comprising: a mobile support (10) adapted so as to be displaced along to the path; an encoder (20) adapted so as to deliver representative signals of the distance covered by the mobile support along the path; a camera (30) adapted so as to acquire individual views of the path with very high definition and having a port for remote control of the shots; and a control box (40) receiving said signals from the encoder (20) and capable of remotely controlling the acquisition of views by means of the camera (30) according to the distance covered by the mobile support (10).

### GENERAL TECHNICAL FIELD

The invention relates to a system for acquiring views of a path and finds application in the making of <<virtual tours>> for example on the Internet. The invention also relates to a method for acquiring views of a path as well as to a method for achieving a virtual tour along a path.

### STATE OF THE ART

Virtual tours or strolls give the possibility of virtually visiting locations, without moving, while having the impression of moving in these locations naturally. Virtual strolls are broadcasted from a server for display on a screen and may be accessible via the Internet network by means of a computer, a mobile phone, etc.

The traditional way to achieve a virtual stroll is to have an operator who moves with a video camera along a given path in the location, the visit of which is desired, and acquires a video sequence of the location.

However, the obtained videos are of low quality, even if advances have recently been made with high definition video.

Further, the making of a quality video sequence involves a highly regular displacement of the camera on the path, not only in terms of orientation of the camera but also in terms of the displacement velocity of the operator.

Now, there exists today a need for achieving virtual strolls of very high quality notably for commercial purposes for visiting prestigious properties (hotels, real estate, etc.).

### PRESENTATION OF THE INVENTION The aim of the invention is to allow virtual strolls in a location to be made with very high quality.

According to a first aspect, the invention relates to a system for acquiring a plurality of views of a path comprising: a mobile support suitable for being moved along the path; an encoder suitable for delivering representative signals of the distance covered by the mobile support along the path, a camera suitable for acquiring individual views with a high definition of the path and having a port for remotely controlling the taking of shots; and a control box receiving said signals from the encoder and capable of remotely controlling the acquisition of views by means of the camera according to the distance covered by the mobile support.

Advantageously, the control box comprises a means for adjusting the distance to be covered by the mobile support between two successive acquisitions.

According to a second aspect, the invention relates to a control box for controlling the acquisition of a plurality of views of a path, characterized in that it comprises an input for the representative signals of a distance covered by a mobile support suitable to be displaced along the path, and an output for remotely controlling a camera for controlling the acquisition of individual views with a very high definition according to said distance.

According to a third aspect, the invention relates to a method for acquiring a plurality of views of a path by means of an acquisition system, the first aspect of the invention, the method comprises the following steps: displacement of the mobile support along the path; acquisition of the representative information on the distance covered by the mobile support along the path by means of the encoder; control of an acquisition of a view by means of the control box every time a given distance has been covered by the support; and acquisition of the view.

According to a fourth aspect, the invention relates to a method for generating an animated sequence with a very high definition, notably of a virtual stroll along a path, characterized in that it comprises the editing of the individual shots for making a virtual stroll along a path from views of the path acquired by the method according to the third aspect of the invention comprising editing of the acquired views in order to form an animated sequence legible by a reader software package.

By the combination of accurate control of the acquisition of views along the path by means of a camera, the path is photographed accurately with good quality. Further, the linking of the individual shots is independent of the variations of the speed of the mobile support, since it is the covered distance which determines the instant at which each view is acquired.

Thus an extremely stable, fluid, sharp animated sequence of a location is thereby obtained and with a quality above the one obtained with known techniques.

With the invention it is possible to make virtual strolls notably in hotels, real estate, museums, retreat centers, boats, conference rooms, exhibitions, shows and fairs, or further in ports, airports, railway stations, public buildings, stadiums, amusement parks, monuments, public works' structures, sports and military centers, etc.

### PRESENTATION OF THE FIGURES

Other features, objects and advantages of the invention will further become apparent from the description which follows, which is purely illustrative and non-limiting and should be read with reference to the appended drawings wherein:

FIG. 1 schematically illustrates an acquisition system according to the invention;

FIG. 2 illustrates a view acquisition chain of the system according to the invention;

FIG. 3 illustrates an acquisition method according to the invention;

FIG. 4 illustrates the making of a video of a stroll along the path of FIG. 3.

### DETAILED DESCRIPTION OF THE INVENTION

1) System for taking shots

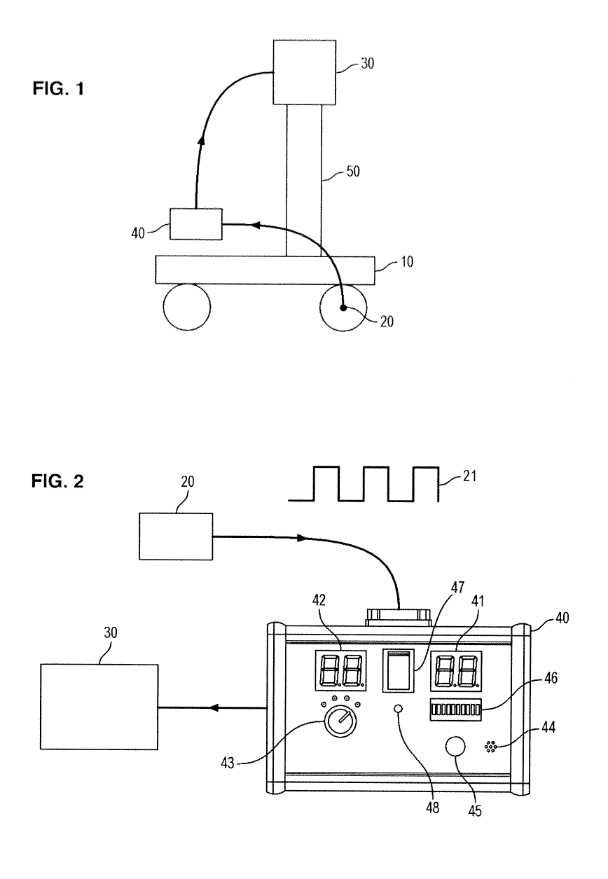

FIG. 1 illustrates a system for acquiring a plurality of views of a path in order to form a sequence of very high quality moving images.

The acquisition system comprises a mobile support 10 intended to be displaced along the path.

The system comprises an encoder 20 in order to measure a distance covered by the mobile support along the path.

The mobile support 10 is for example a carriage with three or four wheels, and in this case the encoder 20 is preferably associated with the rotation of one of the wheels.

The encoder 20 is for example connected to a wheel by a frictional pulley, cog, belt transmission, etc., in such a way that to a rotation by a given angle of the wheel corresponds a pulse of the encoder. The encoder 20 is for example of the optical, magnetic or electromechanical type, the person skilled in the art having a wide range of products available on the market. It is understood that to each pulse delivered by the encoder corresponds a constant distance covered by the carriage. Advantageously, at least one of the wheels of the carriage is idle or swiveling so as to allow changes in the direction of the carriage.

The system further comprises a digital camera 30 for acquiring individual shots. This may be for example a commercial digital reflex camera, equipped with an objective with a focal length adapted to the environment, giving a field width close to that of the human eye, and capable of taking individual images with very high definition (with for example a 10 to 20 Mpixel sensor).

Finally, the acquisition system comprises a control box 40 connected to the encoder 20 on the one hand and to the camera 30 on the other hand and capable of controlling the acquisition of views by means of the camera 30. More specifically, it is according to the distance covered by the mobile support 10 that the individual shots are triggered.

Alternatively, the encoder 20 can be replaced by the combination of signal transmitters arranged on the floor with a signal receiver embedded on the carriage, The signal transmitters can be placed in the corners of the space in which the carriage is moving. The distance is obtained from the distance covered by the carriage which is obtained by the difference between the signal strength of received signals. The distance measured is then transmitted to the control box 40 which triggers a shot with the camera 30 according to the chosen distance between two shots.

Still alternatively, to measure the distance a device for generating a laser beam or a photosensitive cell may be embedded on the carriage, The distance between the carriage and the first wall of the space in which the carriage is moving is continuously measured. The distance measured is then transmitted to the control box 40 which triggers a shot with the camera 30 according to the chosen distance between two shots.

2) Acquisition chain FIG. 2 illustrates a chain for acquiring views of the system of FIG. 1. The encoder 20 here delivers a square signal, each square pulse representing a set covered distance, for example comprised between 0.1 and 10 cm.

A processing unit (not shown, for example a microcontroller) contained in the box 40 processes both received signals. The processing consists of carrying out counting of the square pulses received from the encoder in order to trigger a shot by means of the camera 30 every time a given count is reached. This triggering is carried out via the remote control port conventionally provided on most medium range and high range digital cameras.

The control box 40 comprises an adjustment member such as a selector 43 with which the acquisition distance between two successive images may be adjusted, i.e. the value of the count which, when it is reached, triggers a shot. Advantageously, the value of this count is adjustable so that a shot is taken for example every 0.1 to 100 cm, notably depending on the type of environment, on the sought fluidity for the moving images and on the processing capacities of the reader software package.

Moreover, the box advantageously includes display units 41 and 42 with which the distance covered by the mobile support and its instantaneous or average displacement speed may be displayed.

For purposes of sound control, provision may be made at each triggering of a shot, for the box to emit a sound signal delivered by a transducer 44.

3) Shooting process

By means of the system described above, a series of views of a path is acquired after having adjusted the desired shooting rate by means of the selector 43.

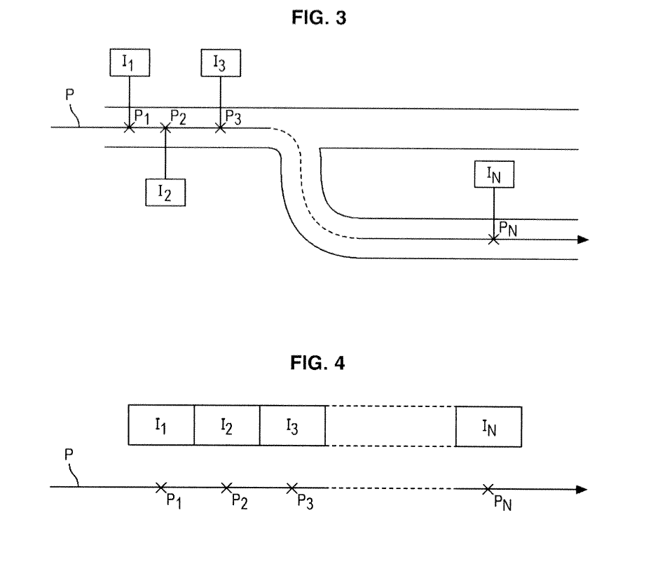

FIG. 3 illustrates a path P on which the mobile support 10 will be displaced manually.

During the displacement, the encoder connected to the control box 40 provides square pulses to the central unit which triggers a shot every time a given distance is covered.

In FIG. 3, equidistant positions P₁, P₂, P₃, . . . P_{N} on the path P are illustrated. To each position P₁-P_{N} corresponds an acquired view I₁-I_{N}.

4) Producing a virtual stroll along a path

In order to produce a stroll along a path P, the views are edited so as to form a sequence of moving images legible as a video sequence during reading (see FIG. 4).

The display duration of each view is comprised between ⅕^{th} of a second and 1/100^{th} of a second, this parameter may be adjusted upon editing.

The result is an extremely stable, fluid, sharp video of a location with a substantially greater quality than what is obtained with a HD video camera.

Further, because the shots are controlled depending on the actual displacement of the support, the system is not dependent on speed variations unlike shooting with a video camera where the interval between the individual shots has a constant duration and is generally non-adjustable.

1. A system for acquiring a plurality of views of a path comprising:
a mobile support (10) suitable for being displaced along the path;
an encoder (20) adapted so as to deliver representative signals of the distance covered by the mobile support along the path;
a camera (30) adapted for acquiring individual views with very high definition of the path and having a port for remote control of the shots; and
a control box (40) receiving said signals from the encoder (20) and capable of remotely controlling the acquisition of views by means of the camera (30) according to the distance covered by the mobile support (10), the distance being comprised between 0.1 cm and 100 cm.

2. The system according to claim 1, wherein the control box (40) comprises a means for adjusting the distance to be covered by the mobile support between two successive acquisitions.

3. A control box for controlling the acquisition of a plurality of views of a path, characterized in that it comprises an input for signals representative of a distance covered by a mobile support adapted so as to be displaced along the path, and an output for remotely controlling a camera (30) for controlling the acquisition of individual views with very high definition according to said distance.

4. A method for acquiring a plurality of views of a path by means of an acquisition system according to one of claims 1 and 2, characterized in that it comprises the following steps:
displacement of the mobile support along the path;
acquisition of information representative of the distance covered by the mobile support along the path by means of the encoder;
controlling an acquisition of a view by means of the control box every time a given distance has been covered by the support; and
acquisition of the view.

5. A method for generating an animated sequence with very high definition, notably of a virtual tour along a path, characterized in that it comprises the editing of the individual shots for achieving a virtual stroll along a path from views of the path acquired by the method according to claim 4 comprising edition of the acquired views in order to form an animated sequence legible by a reader software package.
